(19) United States
(12) Patent Application Publication
(10) Pub. No.: US 2008/0069591 A1
(43) Pub. Date: Mar. 20, 2008

(54) Gap controlling structure for image forming apparatus

(75) Inventors: Cheng-Yi Lai, Hsinchu (TW); Chin-Lung Han, Hsinchu (TW)

Correspondence Address: RABIN & Berdo, PC, 1101 14TH STREET, NW, SUITE 500, WASHINGTON, DC, 20005, US

(73) Assignee: AETAS TECHNOLOGY, INCORPORATED, Irvine, CA (US)

(21) Appl. No.: 11/522,338

(22) Filed: Sep. 18, 2006

(51) Int. Cl. G03G 15/00; G03G 15/08

(52) U.S. Cl. 399/162; 399/279

(57) ABSTRACT

A gap controlling structure for image forming apparatus for maintaining a development gap between a photoconductor of an image-receiving module and a developer roller of a developer unit includes a image-receiving module frame, and at least a photoconductor support bar. The photoconductor support bars are combined on the image-receiving module unit frame. Each of the photoconductor support bars has a raised curved surface. The developer unit has at least a toner cartridge disposed corresponding to the curved surfaces. The distance between the toner cartridges is maintained by the photoconductor support bars supporting the photoconductor. The developer unit further includes a roller gap controlling apparatus to improve a gap accuracy of positioning the developer roller.

### BACKGROUND

1. Field of Invention

The present invention relates to a gap controlling structure for an image forming apparatus. More particularly, the present invention relates to a structure of electrophotography image forming apparatus for maintaining a development gap formed between an image-receiving member of an image-receiving module and a developer roller of a developer unit.

2. Description of Related Art

An electrophotography (EPG) image forming apparatus may form an image using the EPG method. The EPG method includes a charging step, an exposure step, a developing step, a transferring step, and a fusing step.

The charging step may use a charger to charge an electrostatic charge on a surface of an image-receiving member, a photoconductor surface for example, to form a charge area. In the exposure step, an image to be printed may be converted into an optical signal and irradiated by using a light-emitting diode (LED) or a laser on the charge area of said photoconductor to form a latent image area.

In the developing step, the toners sent by a developer unit may jump onto the latent image area of the photoconductor to develop the latent image. After the developing step, the toners on the photoconductor may be transferred onto a paper or other medium during the transferring step. Finally, a hot roller and a pressure roller may fuse the toners on the paper in the fusing step.

In the non-contact developer unit, the toners may jump across a gap between the developer roller of the developer unit and the photoconductor of an image-receiving module and adhere to the latent image of the photoconductor. Thus a gap controller of the developer unit and the image-receiving module may affect a quality of the image forming.

The conventional image-receiving member may be a photoconductor, more particularly, an organic photoconductive belt (OPC belt). The OPC belt may be rolled on a support structure. The conventional support structure is joined by screws and a deformation is generated so that the OPC belt cannot be rolled on the support structure smoothly. Further, a position difference between the developer roller and a roller supporter may be generated after assembling the developer unit. The position difference may reduce the accuracy of the gap between the developer roller and the photoconductor.

The above situation may cause an unequal gap between the developer roller and the photoconductor and the toners cannot be jumped on the photoconductor equally.

For the forgoing reasons, there is a need for maintaining the gap between the developer roller and the photoconductor to improve the toner image forming quality.

### SUMMARY

The invention provides a gap controlling structure for image forming apparatus to maintain a gap between an image-receiving member of an image-receiving module and a developer roller of a developer unit. The gap controlling structure for image forming apparatus includes an image-receiving module frame, at least a photoconductor support bar, and a photoconductor. The image-receiving module frame has an axle and each photoconductor support bar has two ends disposed on opposite sides of the axle on the image-receiving module frame. Each photoconductor support bar has a raised bar parallel to the axle. The photoconductor is disposed on the image-receiving module frame and the photoconductor support bars. The developer unit has at least a toner cartridge disposed corresponding to the raised bars and the photoconductor support bars support the photoconductor, so as to maintains the gap between the photoconductor and the developer roller of the toner cartridges.

The invention also provides a roller gap controlling apparatus for developer unit. The roller gap controlling apparatus for developer unit includes at least a toner cartridge with a developer roller, a roller supporter, and at least a gap controlling member. The roller supporter may support the developer roller and the gap controlling member is stuck on the roller supporter to improve the accuracy of positioning the developer roller in the developer unit.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a lateral view diagram of an embodiment of a gap controlling structure for image forming apparatus of this invention;

FIG. 2A is an exploded view diagram of the embodiment of FIG. 1 of the gap controlling structure for image forming apparatus of this invention;

FIG. 2B is an oblique view diagram of the embodiment of FIG. 2A of the gap controlling structure for image forming apparatus of this invention;

FIG. 3 is a lateral view diagram of another embodiment of the gap controlling structure for image forming apparatus of this invention; and

FIG. 4 is a schematic diagram of a preferred embodiment of a roller gap controlling apparatus for developer unit of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

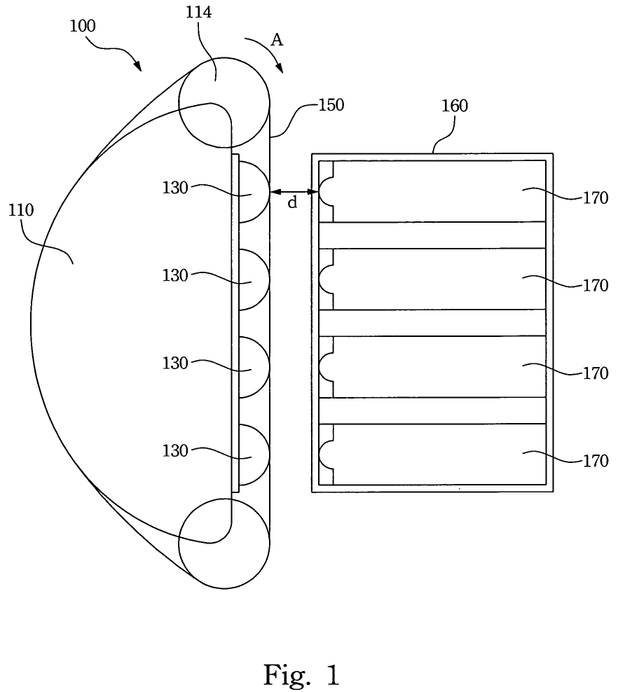

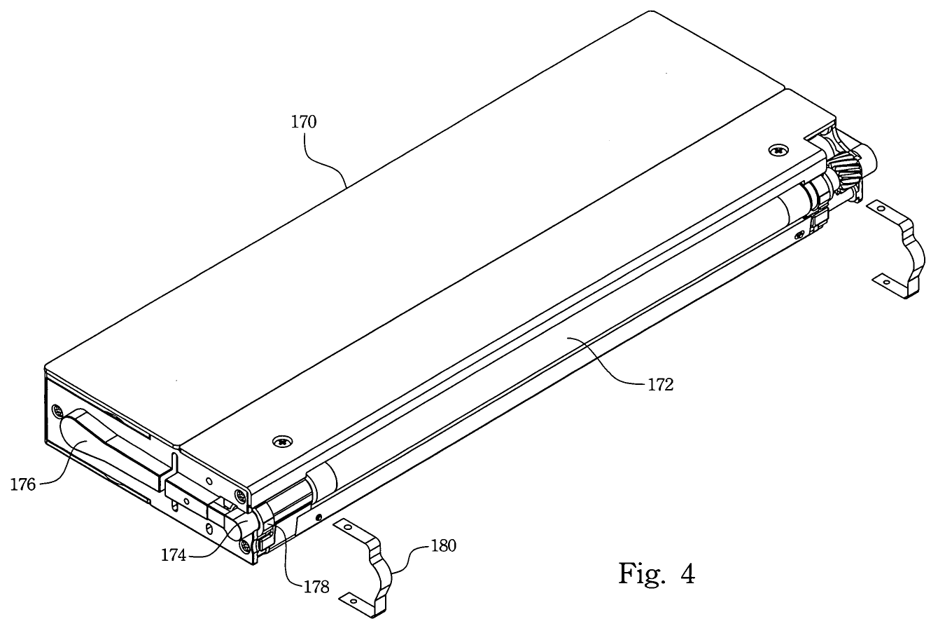

FIG. 1 illustrates a lateral view diagram of an embodiment of a gap controlling structure for image forming apparatus of this invention. The image forming apparatus includes an image-receiving module 100 and a developer unit 160. The image-receiving module 100 includes an image-receiving module frame 110, a photoconductor 150, and at least a photoconductor support bar 130. The photoconductor 150 may be an OPC belt rolled on the image-receiving module frame 110. The photoconductor 150 may be rolled in the direction of arrow A by a plurality of rotating rollers 114. The developer unit 160 may have a plurality of toner cartridges 170. Toners in the toner cartridges 170 may jump to a latent image area on the photoconductor 150 to form an image. The photoconductor support bars 130 are disposed on the image-receiving module frame 110 corresponding to the toner cartridges 170. A gap d between the photoconductor 150 and the developer roller 172 (refer to FIG. 4) of the toner cartridge 170 may be maintained by the photoconductor support bars 130 to improve a quality of image forming.

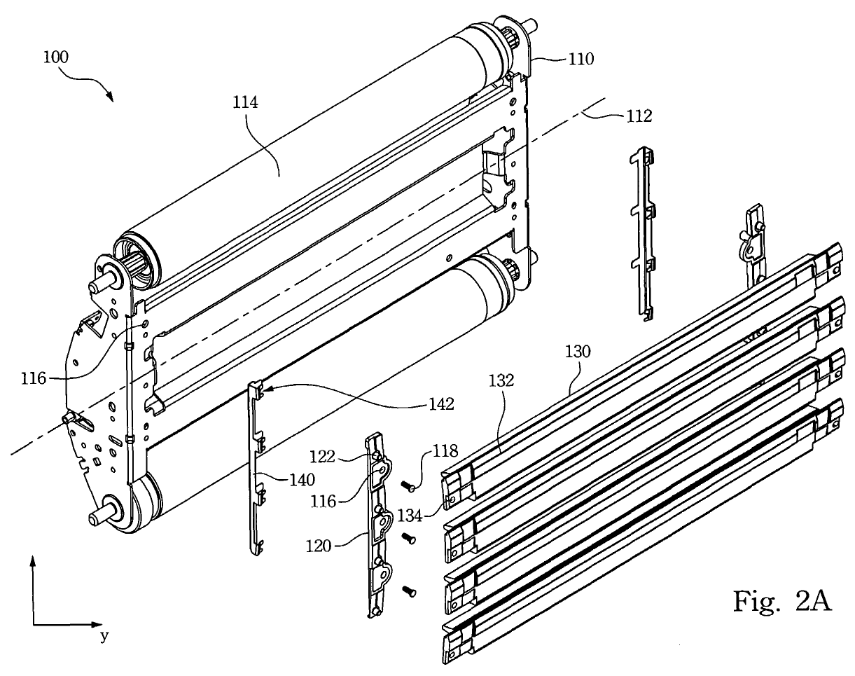

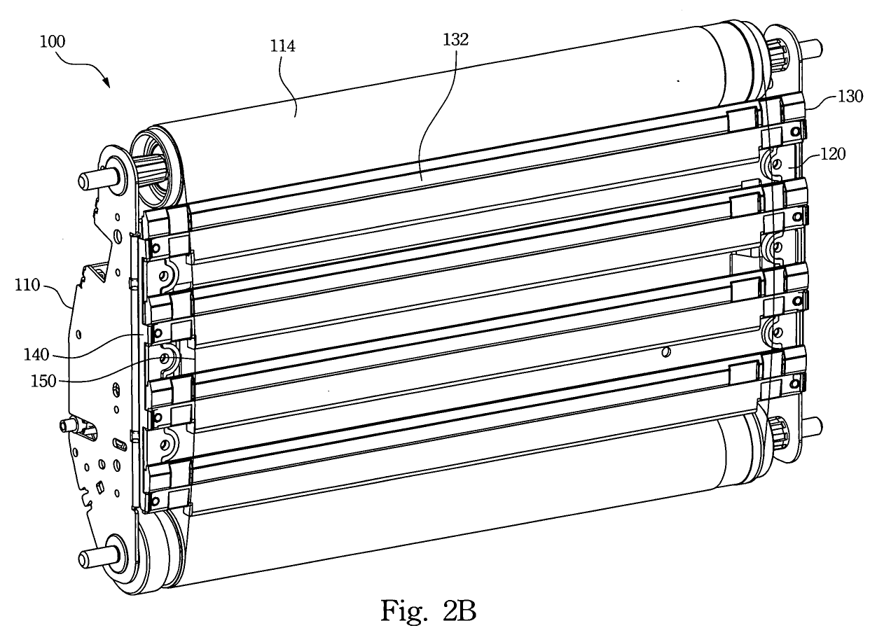

Refer to FIG. 2A and FIG. 2B. FIG. 2A illustrates an exploded view diagram of the embodiment of FIG. 1 and FIG. 2B illustrates an oblique view diagram of the embodiment of FIG. 2A. The image-receiving module frame 110 has an axle 112. Two ends of the photoconductor support bars 130 are fixed on the image-receiving module frame 110 parallel to the axle 112. Each photoconductor support bar 130 supporting the photoconductor 150 is disposed corresponding to a developer roller 172 (refer to FIG. 4) of each toner cartridge 170 in the developer unit 160. Each photoconductor support bar 130 has a raised bar 132 parallel to the axle 112. Each raised bar 132 has a cambered surface. The material of the photoconductor support bar 130 may be an alloy, a metal, or a plastic, especially an anodic processed Al alloy to improve the smoothness of the photoconductor support bar 130 surface.

The image-receiving module 100 may include the rotating rollers 114 disposed on the image-receiving module frame 110 parallel to the axle 112. The photoconductor 150 may be rolled on the image-receiving module frame 110 and the photoconductor support bars 130 by rotating the rotating roller 114. The image-receiving module 100 may further include a plurality of brackets 120 disposed on opposite sides of the axle 112 on the image-receiving module frame 110. The brackets 120 may be fixed on the image-receiving module frame 110 by mounting a plurality of screws 118 with a plurality of screw holes 116 of the brackets 120 and the image-receiving module frame 110. Each bracket 120 has a plurality of protrusions 122 for positioning and each end of the photoconductor support bars 130 has a corresponding cavity 134. The photoconductor support bars 130 may be floating fixed on the brackets 120 by coupling the protrusions 122 with the cavities 134. The brackets 120 has an incline angle and therefore the photoconductor support bars 130 can adjust position angle corresponding to the toner cartridges 170 by the inclined angle and the photoconductor 150 can smoothly roll on the image-receiving module frame 110. The shape of the cavities 134 and the protrusions 122 may be circles. The image-receiving module 100 may further have a plurality of clamps 140 disposed on opposite sides of the axle 112. The clamps 140 may have a plurality of the position holes 142 to couple with the protrusions 122 of the brackets 120 to restrict a movement parallel to the axle 112 of the photoconductor support bars 130.

The photoconductor support bars 130 may be floating fixed on the brackets 120 in the direction y by coupling the cavities 134 with the protrusions 122 and the deformation caused by the conventional screw-fixed support structure may be reduced and the photoconductor 150 may be rolled on the image-receiving module frame 110 smoothly.

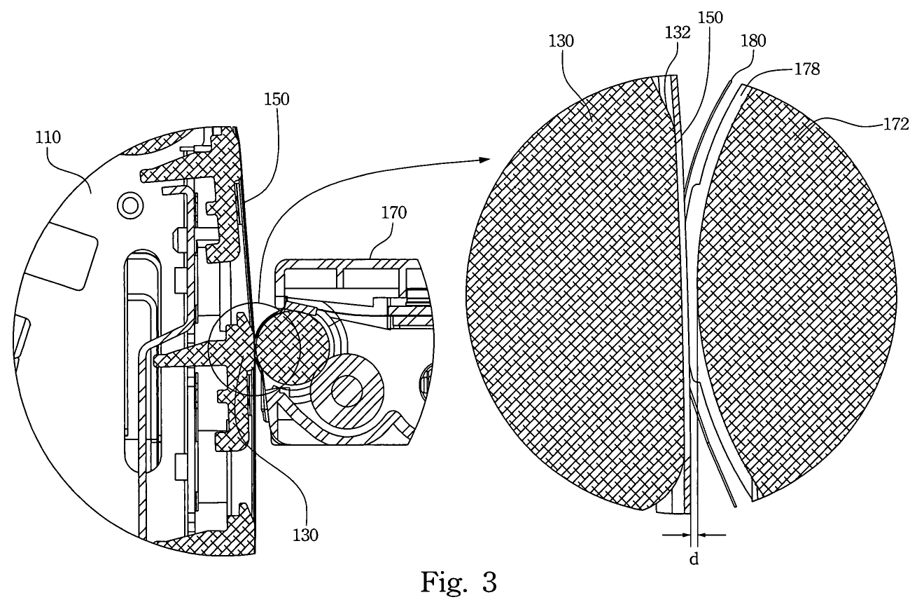

Refer to FIG. 3. FIG. 3 illustrates a lateral view diagram of another embodiment of the gap controlling structure for image forming apparatus of this invention. The gap controlling structure for image forming apparatus may maintain the gap d between the photoconductor 150 and the toner cartridges 170 of the developer unit 160. The photoconductor 150 may be the OPC belt in the embodiment and the OPC belt is rolled on the image-receiving module frame 110 and the photoconductor support bars 130. The toner cartridges 170 of the developer unit 160 are disposed corresponding to the cambered raised bars 132 of the photoconductor support bars 130. The cambered raised bars 132 may support the latent image area of the photoconductor 150 and maintain the gap d between the photoconductor 150 and the developer roller 172 of the toner cartridges 170 of the developer unit 160. A radius of the cambered surface is approximately from 50 mm to 300 mm to smoothly roll the photoconductor 150 on the image-receiving module frame 110. The radius of the cambered surface is approximately 125 mm in this embodiment. There are four photoconductor support bars 130 correspond to four toner cartridges 170 which have different colors in this embodiment.

Refer to FIG. 4. FIG. 4 illustrates a schematic diagram of a preferred embodiment of a roller gap controlling apparatus for developer unit of this invention. Each toner cartridge 170 has a developer roller 172 and a roller supporter 174 to support the developer roller 172. The toners in the toner cartridges 170 are sent by the developer roller 172 and are jumped to the latent image area of the photoconductor 150 by the electrostatic charge. A tolerance of the developer roller 172 or the roller supporter 174 may be generated during producing and a position difference is formed when assembling the developer roller 172 on the roller supporter 174. The image forming quality may be reduced by the unequal gap d caused by the position difference. Thus the toner cartridge 170 needs a roller gap controlling apparatus to precisely adjust the position of the developer roller 172.

Refer to FIG. 3 and FIG. 4. The developer roller 172 is assembled in the roller supporter 174. The roller supporter 174 has two ends and each end of the roller supporter 174 has a position shaft 178 to fix the position of the developer roller 172. The position shaft 178 may have a cambered shape.

The cambered position shaft 178 and the developer roller 172 may be a coaxial disposition and a radius of the cambered position shaft 178 is slightly larger than a radius of the developer roller 172. But the difference in radius between the cambered position shaft 178 and the developer roller 172 is smaller than the gap d. The roller gap controlling apparatus of the toner cartridge 170 may have at least a gap controlling member stuck on the roller supporter 174 to adjust the gap d for improving the accuracy of positioning the developer roller 172 in the developer unit 160. The gap controlling members may be at least a thin slice 180 and the thin slices 180 are stuck on the cambered position shaft 178. A thickness of the thin slice 180 may approximately compensate the distance between the developer roller 172 and the photoconductor 150 to maintain the gap d. The accuracy of positioning the developer roller 172 may be improve by maintaining the gap d with the thin slices 180 while the roller supporter 174 touches the photoconductor support bars 130 to fix the developer roller 172. Furthermore, the gap d between the developer roller 172 and the photoconductor 150 may also be maintained and improve the quality of the toner image forming. The thin slice 180 may be fixed on the position shaft 178 by a contact force between the position shaft 178 and the photoconductor support bars 130. Two ends of the thin slice 180 not facing the photoconductor 150 may be pasted with a glue to further fix the thin slice 180 on the position shaft 178. The thin slices 180 may also be fix with a flexible structure or a clasp.

A range of the thickness of the thin slices 180 is approximately between 15 μm to 65 μm according to the tolerance. The thickness of the thin slice 180 is selected from a group consisting of 20 μm, 25 μm, 30 μm, 35 μm, 40 μm, 45 μm, 50 μm, 55 μm, and 60 μm or other thickness group. A material of the thin slice 180 may be a metal. The material of the thin slice 180 may also be a plastic, such as a mylar.

The gap controlling structure for image forming apparatus of the invention has several advantages. The gap between the photoconductor and the corresponding developer roller may be maintained by the photoconductor support bars supporting the latent image area of the photoconductor. The deformation of the conventional screw-fixed support structure may be reduced and the photoconductor support bars are floating coupled with the brackets by coupling the protrusions and the cavities. Each toner cartridge of the developer unit may have the roller gap controlling apparatus. The distance between the developer roller and the photoconductor may be adjusted by the thin slices to compensate the distance between the developer roller and the photoconductor 150 to maintain the gap to improve the accuracy of positioning the developer roller while the roller supporter touches the photoconductor support bars. The toner image forming quality may be improved by maintaining the gap between the developer roller and the photoconductor by the gap controlling structure for image forming apparatus.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A gap controlling structure for image forming apparatus to maintain a gap between an image-receiving module and a developer unit comprising:
an image-receiving module frame having an axle;
at least a photoconductor support bar, wherein each photoconductor support bar has two ends disposed on opposite sides of the axle on the image-receiving module frame and each photoconductor support bar has a raised bar parallel to the axle; and
a photoconductor rolled on the image-receiving module frame and the photoconductor support bars,
wherein the developer unit has at least a toner cartridge disposed corresponding to the raised bars and the gap is maintained by the photoconductor support bars supporting the photoconductor.

2. The gap controlling structure for image forming apparatus of claim 1, wherein each raised bar has a cambered surface.

3. The gap controlling structure for image forming apparatus of claim of claim 2, wherein a radius of the cambered surface is about 50 mm to 300 mm.

4. The gap controlling structure for image forming apparatus of claim 1, wherein the gap controlling structure for image forming apparatus further comprises a plurality of brackets disposed on opposite sides of the axle on the image-receiving module frame to position the photoconductor support bars.

5. The gap controlling structure for image forming apparatus of claim 4, wherein each bracket has a plurality of protrusions and each end of the photoconductor support bars has a cavity disposed corresponding to the protrusions, wherein the photoconductor support bars are positioned on the brackets by coupling the protrusions and the cavities.

6. The gap controlling structure for image forming apparatus of claim 4, wherein each bracket has an inclined angle and the photoconductor support bars are adjusted angle to correspond to the toner cartridges by the incline angle.

7. The gap controlling structure for image forming apparatus of claim 4, wherein the gap controlling structure for image forming apparatus further comprises a plurality of clamps disposed on opposite sides of the axle to floating-fix the brackets and the photoconductor support bars on the image-receiving module frame.

8. The gap controlling structure for image forming apparatus of claim 7, wherein each bracket has a plurality of protrusions and each clamp has a plurality of position holes disposed corresponding to the protrusions, wherein the positioning holes are coupled with the protrusions to restrict a movement parallel to the axle of the photoconductor support bars.

9. The gap controlling structure for image forming apparatus of claim 1, wherein a material of the photoconductor support bars is an alloy, a metal, or a plastic.

10. The gap controlling structure for image forming apparatus of claim 9, wherein the material of the photoconductor support bars is anodic processed.

11. The gap controlling structure for image forming apparatus of claim 1, wherein each toner cartridges has a roller gap controlling apparatus and the roller gap controlling apparatus comprising:
a developer roller disposed parallel to each photoconductor support bar to send toners to the photoconductor from the toner cartridge; and
a roller supporter to support the developer roller, wherein each ends of the roller supporter has a position shaft in contact with the photoconductor support bars to position the developer roller.

12. The gap controlling structure for image forming apparatus of claim 11, wherein the position shafts and the developer roller are a coaxial disposition.

13. The gap controlling structure for image forming apparatus of claim 11, wherein the roller gap controlling apparatus further comprises at least a thin slice stuck on the cambered shafts of the roller supporters.

14. The gap controlling structure for image forming apparatus of claim 13, wherein a material of the thin slices is a mylar or a metal.

15. The gap controlling structure for image forming apparatus of claim 13, wherein a thickness of the tin slices is between 15 μm to 65 μm.

16. A roller gap controlling apparatus for developer unit comprising:
at least a toner cartridge with a developer roller, wherein toners for image forming are supplied from the toner cartridge by the developer roller;
a roller supporter to support the developer roller; and
at least a gap controlling member stuck on the roller supporter to adjust the positioning of the developer roller.

17. The roller gap controlling apparatus for developer unit of claim 16, wherein each end of the roller supporter has a cambered shaft, wherein the cambered shafts and the developer roller are a coaxial disposition and a radius of the cambered shafts is slightly larger than a radius of the developer roller.

18. The roller gap controlling apparatus for developer unit of claim 17, wherein the gap controlling member is at least a thin slice stuck on the cambered shafts of the roller supporter.

19. The roller gap controlling apparatus for developer unit of claim 18, wherein a thickness of the thin slices is between 15 μm to 65 μm, or the thickness of the thin slices is selected from a group consisting of 20 μm, 25 μm, 30 μm, 35 μm, 40 μm, 45 μm, 50 μm, 55 μm, and 60 μm.

20. The roller gap controlling apparatus for developer unit of claim 18, wherein two ends of the thin slices has a glue or a clasp to further fix the thin slices on the cambered shafts.
